(19) United States
(12) Patent Application Publication
(10) Pub. No.: US 2019/0059604 A1
(43) Pub. Date: Feb. 28, 2019

(54) PORTABLE CHILD BED RAIL

(71) Applicant: JOSE ALEJANDRO JO, Fayetteville, AR (US)

(72) Inventor: JOSE ALEJANDRO JO, Fayetteville, AR (US)

(21) Appl. No.: 16/044,751

(22) Filed: Jul. 25, 2018

Related U.S. Application Data
(60) Provisional application No. 62/549,473, filed on Aug. 24, 2017.

(51) Int. Cl. A47C 21/08; A61G 7/05

(52) U.S. Cl. CPC A47C 21/08; A61G 7/0518

(57) ABSTRACT

There is provided herein an embodiment of a bed rail for use in constraining a child in a bed so that the child does not roll off of the bed and fall to the floor during the night or during a nap. More particularly, an embodiment comprises a frame the folds compactly and can be readily unfolded and installed. In addition to the foldable frame, a cloth, mesh, etc., sleeve or other covering is provided that can be slipped over the frame to provide a surface that will constrain the child after the inventive device is installed.

### CROSS REFERENCE TO RELATED APPLICATIONS

This application claims the benefit of U.S. Provisional Patent Application Ser. No. 62/549,473 filed on Aug. 24, 2017, and incorporates said provisional application by reference into this document as if fully set out at this point.

### TECHNICAL FIELD

This disclosure relates generally to child safety devices and, more particularly, to devices for preventing a child from rolling off of the edge of a bed.

### BACKGROUND

Child bed rails (or rail guards as they are equivalently called) are devices that are designed to be installed at the edge of a bed to prevent an infant or toddler from rolling off of the bed and falling to the floor. The risk of injury in such a circumstance is clear. Alternatively, the child might be placed in a crib but a bed rail allows an existing bed to be used in place of a crib and can help the parents bridge time between when there is a serious risk of falling and when the child is able to sleep without significant risk of this happening.

The use of screens or shields to prevent a child from falling to the floor is well known. Typically, though, these devices are intended to be installed (often with some effort) at a single location and are not practical for use when a parent is traveling. That is, the traveling family is often confronted with a choice between adding a large and cumbersome bed rail to their packed baggage or risking injury to the child during the trip. Further, the installation of the bed rail in a hotel room may require that tools be packed as well and, in some cases, significant time will may need to be invested in assembly and installation, time which might better be used enjoying experiencing the unique features of the vacation stop or destination. Finally, the conventional bed rail may not be adjustable vertically to accommodate different configurations of sleeping surfaces.

As such what is needed is a child bed frame that addresses the shortcomings of prior art devices. In more particular, what is lacking is a device that packs compactly and is easy to set up in a hotel room or other location and can be easily adjusted to conform it to different beds.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

There is provided herein an embodiment of a bed rail for use in constraining a child in a bed so that the child does not roll off of the bed and fall to the floor during the night or during a nap. More particularly, an embodiment comprises a frame that folds compactly and can be readily unfolded and installed. In addition to the foldable frame, a cloth, mesh, etc., sleeve is provided that can be slipped over or attached to the frame to provide a surface that constrains the child.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1A contains a perspective view of the frame of an embodiment.

FIG. 1B contains a perspective view of an embodiment with an example sleeve partially installed.

FIG. 1C contains a view of the embodiment of FIG. 1A, wherein the embodiment is partially folded

FIG. 1D contains a plan view of the embodiment FIG. 1C after it has been further folded.

FIG. 2A contains a detail of one corner of an embodiment.

FIG. 2B contains a detail of the embodiment of FIG. 2A after it has been folded.

FIG. 3 illustrates a version of wherein the one or more of the structural members might be made adjustable in length through the use of a compression fitting.

FIG. 4A contains a schematic illustration of a hinge suitable use with an embodiment.

FIG. 4B contains a cut-away view of the example provided in FIG. 4A.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

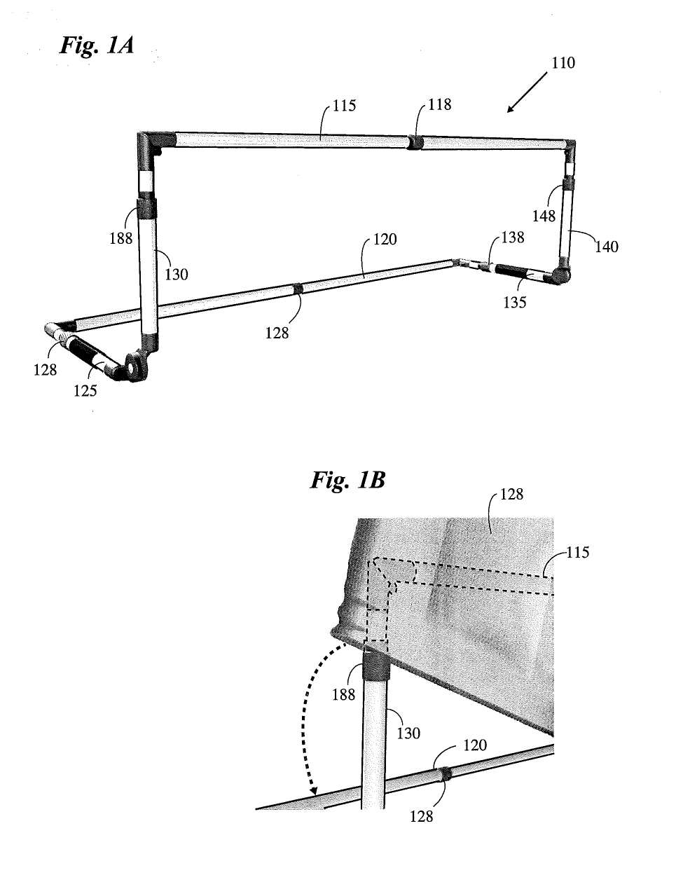

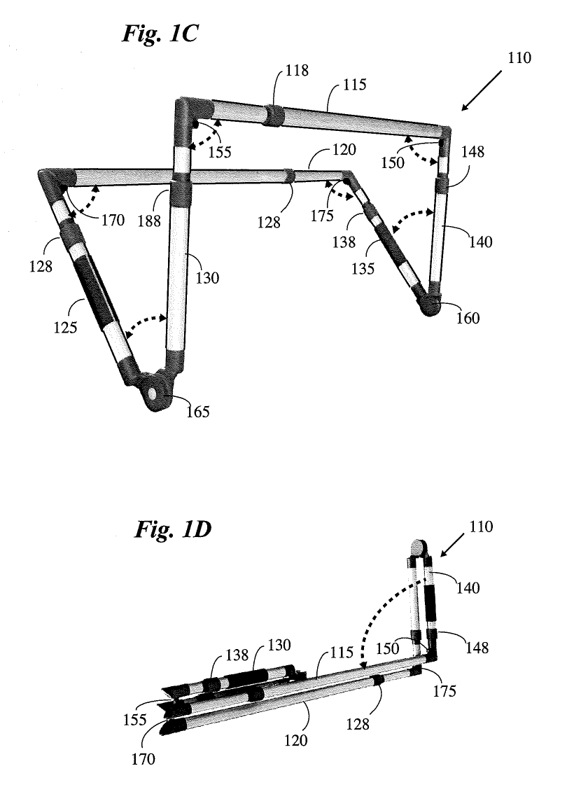

Turning first to FIG. 1B, there is provided an embodiment of a portable child bed rail 100 that comprises a frame 110 that is covered by a cover or case 120. As can be seen in this figure, there is a cover or sleeve 120 that encases substantially all of the upright portion of the frame 110. The sleeve 120 will preferably be removable to assist in the folding of the frame 110 when the bed rail 100 is prepared for transport, although that is not a requirement.

FIG. 1A contains a detailed view of the frame 110 of FIG. 1B. As can be seen, the frame 110 comprises two horizontal cross members 115 and 120 that are joined together via two vertical members 130 and 140 and two lateral extensions 125 and 135. As will be discussed in connection with FIG. 1C below, there is additional structure to the frame 110 that has been eliminated for purposes of clarity in this figure. The frame 110 might be constructed of any suitable material including, without limitation, PVC pipe, aluminum, etc. In some configurations the frame members will be circular in cross section but obviously that is not a requirement. In some embodiments and as an example, the cross sections of some members might be circular and others square. In other embodiments, the members 120, 125, and 135 might be relatively flat to allow them to be affixed more easily to the bed as is discussed below. Those of ordinary skill in the art will be capable of configuring the frame 110 to suit any particular need.

The frame of FIG. 1A is more fully annotated in FIG. 1C to illustrate how the various members cooperate to allow the frame to be folded for transport. As is indicated in the embodiment of FIG. 1C, each of the member members of frame 110 are rotatably joined by hinges 150, 155, 160, 165, 170, and 175. In more particular, vertical members 130 and 140 are joined via hinges 165 and 160 to lateral extensions 125 and 135, respectively, which will allow the cross member 120 to be rotated up and into contact with cross member 115.

Hinges 170 and 175 allow lateral extensions 125 and 135 to be rotated into contact with cross member 120. In the same way, hinges 150 and 155 allow vertical members 130 and 140 to be rotated into contact with cross member 115. The net effect is that, in one embodiment, if extensions 125 and 135 are rotated into contact with vertical members 130 and 140, and then vertical members 130 and 140 are rotated into contact with horizontal member 115, the resulting configuration will resemble the more compact embodiment of FIG. 1D which could be further rotated into a more compact configuration as indicated.

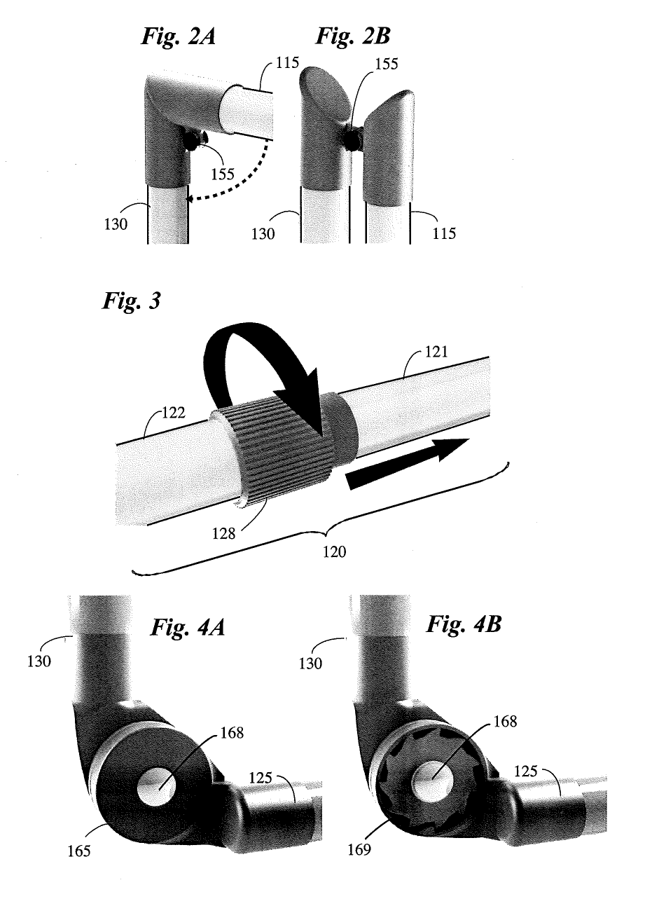

FIGS. 2A and 2B provides a detailed view of one embodiment of the connection between members 115 and 130. FIG. 2A illustrates one approach to making members 115 and 130 rotatable with respect to each other using hinge 155, with FIG. 2B illustrating the result of such rotation.

FIG. 4 contains another example of a suitable hinge embodiment. In this variation, the hinge 165 is made rotatable by pressing switch 168, an exterior view of this configuration being provided in FIG. 4A. FIG. 4B contains a cut-away view to show one example of the interior of hinge 165, wherein a notched wheel 169 is spring loaded to allow it to move freely when the switch 168 is pressed and will be locked into place when the switch 168 is not pressed. Of course, those of ordinary skill in the art will readily be able to devise other sorts of hinges that could be used to connect any of the members 115, 120, 125, 130, 135, and 140 to each other.

In some embodiments, some or all of the members 115, 120, 125, 130, 135, and 140 might be adjustable in length. As is generally indicated in FIG. 3, one way to do this would be to manufacture one or more of the members 115, 120, 125, 130, 135, and 140 in two pieces. FIG. 3 contains an illustration of how this might be done for member 120. In this case, member 120 is comprised of two members 121 and 122 that are sized in such a way that member 121 can be slideably mated with or nested within member 122 and be movable with respect to that member, thereby lengthening or shortening member 120. Then, and according to this particular example, a compression fitting 128 could be used to permit or restrict this movement as is conventionally done, e.g., it could be loosened to allow member 121 to move horizontally and tightened to lock it into place. Other examples might include a mechanism for adjusting the length of one or more of the members 115, 120, 125, 130, 135, and 140 that comprises a depressible detent, e.g., a spring-loaded ball bearing or similar item, that could be pressed against its spring to allow the two nested members 121/122 to slide relative to each other. The ball bearing would then snap into the pre-drilled holes in the exterior member (e.g., member 122) in order to arrest the relative movement of the two nested pieces as is conventionally done. Any one or more of the other components of frame 110 might be similarly adjustable in length depending on the needs of the user.

Finally, in practice the frame 110 of the embodiment 100 would be unpacked/ unfolded from its configuration in FIG. 1D to the upright configuration of FIG. 1A. In some embodiments, the horizontal member 120 would be inserted beneath the mattress of the bed, between the mattress and box springs, under the box springs, etc., or otherwise secured to the bed so that the frame 110 is in close contact with the bed and so that the frame 110 would remain upright and be able to resist at least some pressure from the sleeping child if the child were to roll against it. In some embodiments, the frame 110 could also be inserted underneath the cushions of a couch, chair, other furniture item, etc.

According to one embodiment, the sleeve 128 (FIG. 1B) will be slipped over the frame to provide a solid barrier that will act to prevent a sleeping child from inadvertently rolling off of the sleeping surface. Preferably, the sleeve 128 will be tautly mounted on the frame 110 so that it can act as a barrier. Although some embodiments of the sleeve 128 are open at the bottom to allow it to be slipped over the frame 110, other embodiments might utilize a sleeve that contains Velcro® or some other fastening mechanism on its outer periphery to allow it to be secured to the frame 110 (e.g., grommets and ties could also be used, as could snaps, etc.). In some embodiments, the sleeve 128 might be attachable to the frame 110 in such a way that it could be adjusted in length and/or height if the horizontal members 115 and 120 were similarly adjustable. In other embodiments, the sleeve 120 might be manufactured to be wrapped around the frame and secured with snaps, Velcro®, etc. Those of ordinary skill in the art will recognize that there are many ways the sleeve 120 could be removably attached to the frame 110 so that it is taut enough to provide a barrier. Needless to say, if the sleeve 128 were made to be removable, that would make it easier to compactly fold and store the device 110. However, removability is not a requirement.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A portable child bed rail, comprising:
a. an upper horizontal member having a first end and a second end;
b. a first vertical member having a first upper end and a first lower end, wherein said first upper end is rotatably attached to said upper horizontal member first end;
c. a second vertical member having a second upper end and a second lower end, wherein said second upper end is rotatably attached to said upper horizontal member second end;
d. a first lateral extension having a first proximate end and a first distal end, wherein said first proximate end is rotatably connected to said first lower end;
e. a second lateral extension having a second proximate end and a second distal end, wherein said second proximate end is rotatably connected to said second lower end;
f. a lower horizontal member having a first end and a second end, wherein said lower horizontal member is rotatably attached to said first lateral extension distal end and said lower horizontal member second end is rotatably attached to said second lateral extension distal end; and
g. a removable sleeve, said removable sleeve positionable to fit over said upper horizontal member and at least a portion of said first and second vertical members.

2. The portable child bed rail according to claim 1, wherein said first and second vertical members are adjustable in length.

3. The portable child bed rail according to claim 2, wherein each of said first and second vertical members are adjustable in length via a depressible detent.

4. The portable child bed rail according to claim 1, wherein said sleeve contains a plurality of fasteners attached thereto for affixing said sleeve to said upper horizontal member, said first vertical member and said second vertical member.

5. The portable child bed rail according to claim 1, wherein said sleeve is cloth or mesh.

6. The portable child bed rail according to claim 1, wherein each of said upper horizontal member, first and second vertical members, each of said first and second lateral extensions, and said lower horizontal member are adjustable in length.

7. The portable child bed rail according to claim 1,
wherein said upper horizontal member is adjustable in length, and wherein said upper horizontal member comprises a first upper horizontal element and a second upper horizontal element, wherein said second upper horizontal element is slideably nested within said first upper horizontal element, and
wherein said lower horizontal member is adjustable in length, and wherein said lower horizontal member comprises a first lower horizontal element and a second lower horizontal element, wherein said second lower horizontal element is slideably nested within said first lower horizontal element.

8. The portable child bed rail according to claim 1,
wherein said first vertical member is adjustable in length, and wherein said first vertical member comprises a first upper element and a first lower element, wherein said first upper element is slideably mated with said first lower element, and
wherein said second vertical member is adjustable in length, and wherein said second vertical member comprises a second upper element and a second lower element, wherein said second lower upper element is slideably mated with said second lower element.

9. The portable child bed rail according to claim 1, wherein said sleeve contains a plurality of fasteners attached thereto for affixing said sleeve to said upper horizontal member, said first vertical member and said second vertical member.

10. The portable child bed rail according to claim 1, wherein each of said upper horizontal member, first and second vertical members, each of said first and second lateral extensions, and said lower horizontal member is made of PVC pipe.
